(19) United States
(12) Patent Application Publication
(10) Pub. No.: US 2011/0026504 A1
(43) Pub. Date: Feb. 3, 2011

(54) CONTINUOUS GROUP OWNERSHIP IN AN IEEE 802.11 WIRELESS LOCAL AREA NETWORK

(75) Inventor: Paul Feinberg, River Vale, NJ (US)

Correspondence Address: MAYER & WILLIAMS PC, 251 NORTH AVE. WEST, 2ND FLOOR, WESTFIELD, NJ, 07090, US

(73) Assignees: SONY CORPORATION, Tokyo (JP); SONY ELECTRONICS INC., Park Ridge, NJ (US)

(21) Appl. No.: 12/534,037

(22) Filed: Jul. 31, 2009

(51) Int. Cl. H04W 40/00

(52) U.S. Cl. 370/338

(57) ABSTRACT

A method is provided that includes participating in a peer-to-peer wireless communications network that includes a group controller for creating and ending the network and controlling access to the network by wireless stations. A member of the network receives a status indicator from the group controller indicating that the group owner is or will be no longer serving as group owner.

### FIELD OF THE INVENTION

The present invention relates generally to wireless local area network and more particularly to peer-to-peer wireless local area networks that conform to IEEE 802.11.

### BACKGROUND OF THE INVENTION

In a wireless local area network (WLAN) environment, an access point (AP) may serve as an intermediary between wireless communication stations and a wired network that offers broadband service. Network data to be delivered to a particular wireless communication station traverses the network and reaches the access point, which in turn transmits the data to the particular wireless communication station. An access point may extend service to many wireless communication stations at once. Conventionally, an access point transmits data to wireless communication stations by addressing each packet to an individual communication station. In recent years, wireless data communication in domestic and enterprise environments have become increasingly commonplace and an increasing number of wireless communication networks have been designed and deployed. In particular, the use of wireless networking has become prevalent and wireless network standards such as IEEE 802.11a, 802.11b, 802.11g and 802.11n (collectively “IEEE 802.11”) have become commonplace.

WLANs may be classified by their architecture. In an infrastructure network, wireless devices communicate via an RF connection to an access point. A home WLAN typically will be served by a single access point, such as a wireless router. Wireless devices within the RF coverage area of the wireless router connect to the broadband service of the wired network via the single access point. Wireless devices may also communicate with each other via the single access point. In a mobile ad-hoc network, wireless devices, such as laptops outfitted with wireless modems, communicate directly with each other in a peer-to-peer (P2P) mode. Although ad-hoc P2P WLANs may employ an AP-like device to perform various administrative functions, they do not employ a dedicated AP through which other wireless devices communicate.

Regardless of whether a dedicated AP or an AP-like device is employed, it represents a single point of failure in the WLAN that can prevent all the wireless devices from communicating with one another.

### SUMMARY OF THE INVENTION

In accordance with the present invention method is provided that includes participating in a peer-to-peer wireless communications network that includes a group controller for creating and ending the network and controlling access to the network by wireless stations. A member of the network receives a status indicator from the group controller indicating that the group owner is or will be no longer serving as group owner.

In accordance with another aspect of the invention, a wireless station includes an RF interface configured to exchange wireless signals with remote devices over peer-to-peer connections in a wireless communications network having a group controller for creating and ending the network and controlling access to the network by the remote devices. The wireless station also includes a processor configured to detect a status indicator from the group controller indicating that the group owner is or will be no longer serving as the group owner.

### BRIEF DESCRIPTION OF THE DRAWINGS

FIG. 1 shows the basic network architecture of one example of a wireless local area network (WLAN) with a single access point access point (AP).

FIGS. 2-4 show various illustrative network topologies that represent common use cases for a peer to peer (“P2P”) WLAN.

FIG. 5 shows one illustrative way to set up a Wi-Fi P2P network by associating two stations with one another.

FIG. 6 shows one example of the data frame body used in the IEEE 802.11 standards.

FIG. 7 shows one example of a wireless station that may operate in a wireless P2P network that conforms to a standard such as IEEE 802.11, for example.

FIG. 8 is a flowchart illustrating one example of a method for establishing a peer-to-peer wireless communications network.

### DETAILED DESCRIPTION

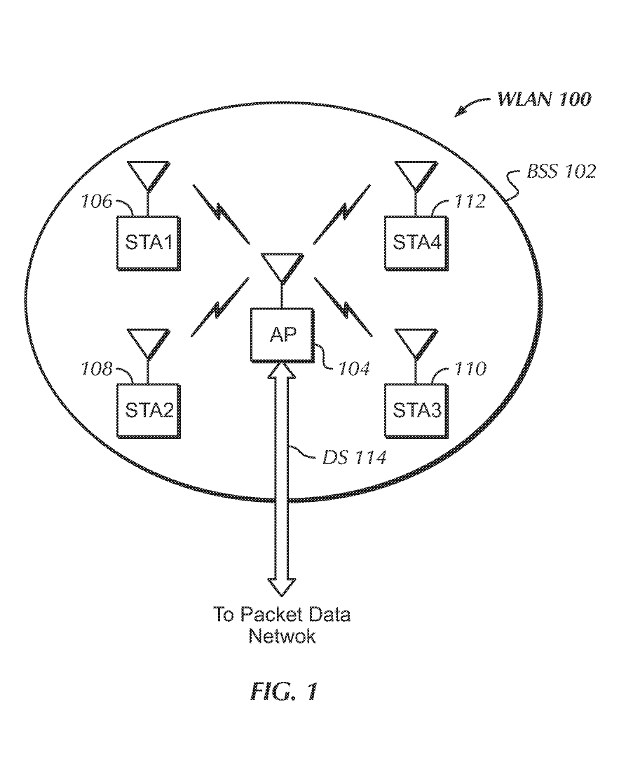

FIG. 1 shows the basic network architecture of a WLAN 100 with a single access point AP 104. For purposes of illustration the nomenclature of the IEEE 802.11 standards is used herein. A WLAN that conforms to the IEEE 802.11 standards may also be referred to as a Wi-Fi network. In a WLAN, any addressable device may be called a station (STA). Stations may be fixed, portable, or mobile. A portable station is a device which is capable of being moved from place to place, such as a laptop which may be moved from one desk to another. During operation, however, a portable device is stationary. A mobile station is a user device, such as a laptop or personal digital assistant, which is in actual motion during operation. In FIG. 1, four stations, STA1 106-STA4 112, are shown. The stations STA1 106-STA4 112 communicate over RF links with access point AP 104, which connects via distribution system DS 114 to a packet data network, details of which are not shown. An example of a distribution system is a wired Ethernet local area network (LAN).

Hereafter, the term “station” (STA) includes, but is not limited to, a wireless transmit/receive unit (WTRU), user equipment, a fixed or mobile subscriber unit, a pager, or any other type of device capable of operating in a wireless environment.

An AP may be considered as a special class of a station. It provides management service, as well as access service for other stations associated with the access point to the distribution system. The area over which an access point provides service is referred to as the basic service area (BSA). The BSA is approximately defined by the RF coverage of the access point, and is nominally fixed. Changes in the RF environment, such as arising from building reconstruction or movement of large equipment, however, may alter the BSA topology.

Stations within the BSA form a network connection to a WLAN by becoming associated with the access point. The set of stations associated with an access point is referred to as the basic service set (BSS) of the access point. These stations are also referred to as members of the associated BSS. In WLAN 100, the basic service set BSS 102 of the access point AP 104 is the set of stations STA1 106-STA4 112 associated with access point AP 104. In FIG. 1, the oval representing BSS 102 pictorially indicates the region of the BSA. The IEEE 802.11 standards, however, labels the region with the associated BSS. This convention is followed herein. Association provides several functions. An important one is mapping a network address of a station to a network address reachable by the packet data network via the DS. At any given instance, an STATION is associated with one and only one AP. Since stations may move in and out of the BSA, the BSS of an access point in general is dynamic. If the set of associated stations does not change, then the BSS is static.

Recently, various approaches have been proposed to enable wireless peer-to-peer connectivity so that users can connect a wide variety of consumer electronic devices and mobile handsets. One proposal from the Wi-Fi Alliance eliminates the need for a dedicated AP by allowing any station to an ad hoc WLAN to serve as an AP-like entity. A station that functions in this capacity is referred to as a peer-to-peer (P2P) group owner, or simply the group owner.

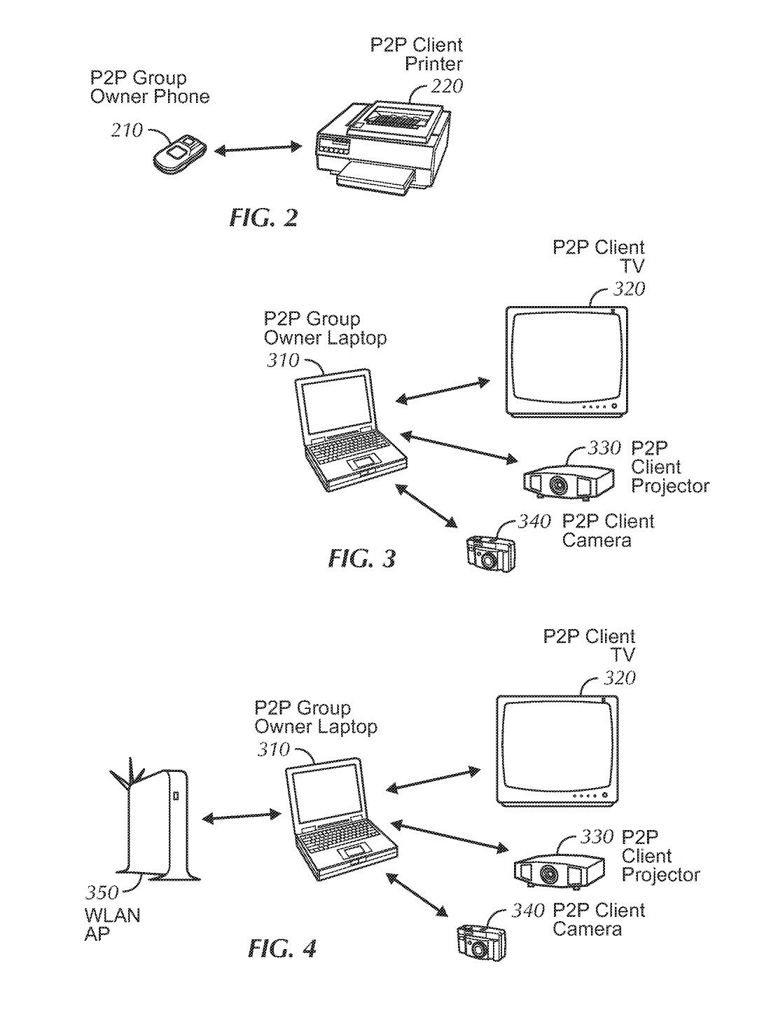

FIGS. 2-4 show various network topologies that represent common use cases for a P2P WLAN. FIG. 2, instance, shows a P2P group that involves only two devices, mobile phone 210 and printer 220, which communicate with each other in a point-to-point relationship. In this example the mobile phone 210 serves as the P2P group owner and the printer 220 serves as the client. FIG. 3 illustrates a topology in which multiple devices communicate with each other, one of which serves as the group owner. In this example a laptop computer 310 is the P2P group owner and a television 320, projector 330 and camera 340 are the P2P clients. FIG. 4 shows an example in which the P2P group shown in FIG. 3 is further in communication with a wireless LAN (WLAN) 350 via the P2P group owner 3 10. It should be noted that none of the network topologies depicted in FIGS. 2-4 include a dedicated AP.

When a Wi-Fi P2P group is first formed the P2P devices negotiate as to which of the devices will serve as the group owner. The group owner serves a number of functions, including, for example, creating and ending the P2P group, controlling admission to the group, discovering which devices are delivering a service, inviting a device to join the group, authenticating a new P2P device (if required) and supplying credential and network information (e.g., a group ID and password) to allow a non-P2P device to be manually configured so that it can join the group.

Stations enter a BSS by associating with one another. An association service is used to make a logical connection between the stations. The association process may include a negotiation procedure during which the stations determine which device will serve as the P2P group owner. During the association process MAC and PHY layer frames are exchanged to perform a variety of control and management tasks.

FIG. 5 shows one illustrative way to set up a Wi-Fi P2P network by associating two stations with one another. Of course, the precise number, type and content of frames communicated between the stations to form an association may differ from those shown herein, which are presented for the purpose illustration only. In FIG. 5 station A initiates the process by periodically transmitting a beacon broadcast without necessarily knowing if another station is present and reachable. Such a broadcast may contain the MAC address of the station A. The beacon broadcast may also specify whether station A is willing to serve as the group owner. If station B receives the request frame, it will answer by transmitting a probe response b. The probe response B will indicate if it accepts station A as the group owner. In addition, if authentication is required, station B may also attempt to find the address of station A in its address list of stations allowed to access it during an authentication process. If authentication is successful or not required and if station B accepts station A as the group owner, an authentication frame c is sent by station A to station B. Thereafter an association request d is also sent by station A to station B and the association is finalized when the response e is sent back to the station A by station B.

One particular example of an association process that may be employed involves the use of the master negotiation process currently defined by the Wi-Fi Alliance in the Wi-Fi P2P Specifications issued by the Wi-Fi P2P Technical Task Group, which are hereby incorporated by reference in their entirety. Another example of an association process in the context of IEEE 802.11 when one of the stations serves as the group owner will be presented below.

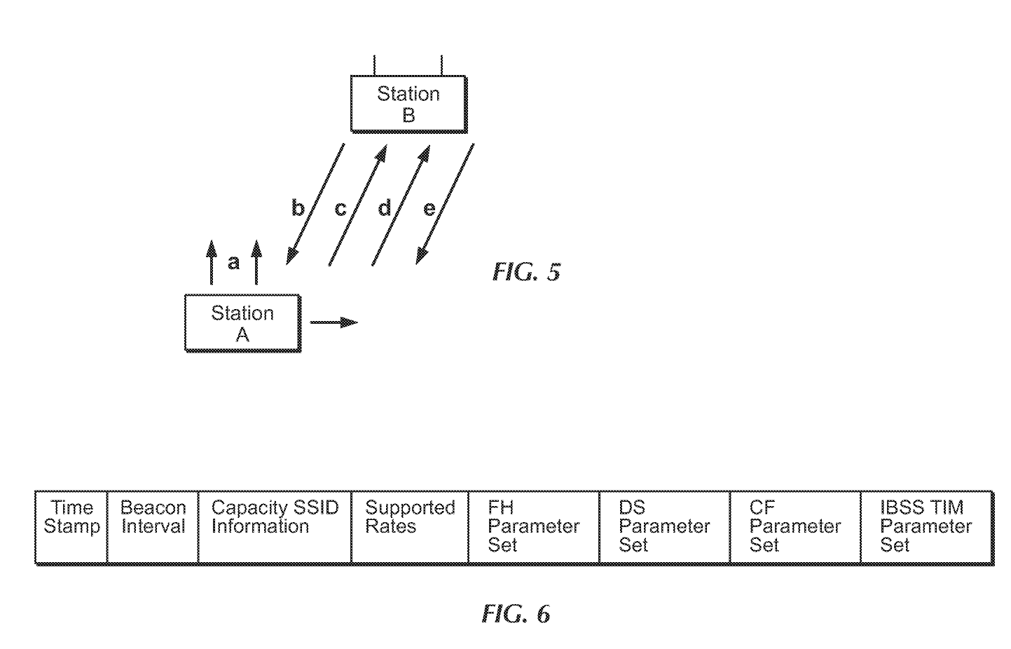

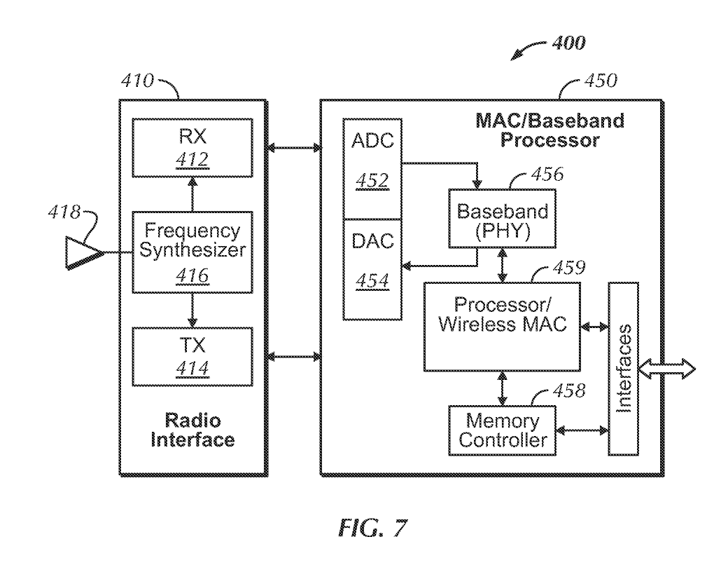

In order to establish the association between two stations in a P2P WLAN in which one of the stations serves as the group owner, a IEEE 802.11 protocol may be employed in which transmission intervals are partitioned into beacon intervals (BIs). A beacon is a frame with a data frame body containing a number of fields that are specified in the IEEE 802.11 standards. The first field contains a timestamp, referenced to the radio clock of the station, and the second field specifies the beacon interval. FIG. 6 shows one example of the data frame body used in the IEEE 802.11 standards.

As seen in FIG. 6, the data frame body exchanged between stations includes fixed fields such as a time stamp, beacon interval, and capability information. The time stamp is a 64 bit field that contains the value of the station's synchronization timer at the time that a frame was transmitted. The beacon interval is the period of beacon transmission. The capability information field is a 16 bit field that identifies the capabilities of the station. The information elements in a beacon transmission typically include the server set identifier SSID, supported rates, physical parameter sets (FH and DS) optional contention free CF parameter set, optional independent basic service set IDSS parameter set, and an optional traffic indication map TIM. The SSID will usually contain the MAC-address of the transmitting station.

One problem that arises when a Wi-Fi network is operated in a P2P mode using one of the stations as the group owner is that the group owner's role is critical during the entire pendency of the connection among the various stations in the P2P network. For instance, if the group owner loses its connection with the other stations in the network, or if the group owner needs to terminate such connections temporarily, all connections involving these stations are totally lost. Therefore, the group owner is a single point of failure in an IEEE 802.11 or Wi-Fi P2P network.

Recovery of the network from such a failure involves recreating its connections at all levels (e.g., physical, logical, link, network, etc.). Unfortunately, this is an involved process requiring tasks such as network querying and the determination of nearby stations. Moreover, authentication and key exchange procedures may also need to be performed for the P2P network to be recovered. Such procedures are undesirable because they require a substantial amount of valuable time. Moreover, disappearance of the group owner may cause data to be lost if the network cannot be reformed.

To overcome or at least ameliorate these problems that arise when a group owner shuts down or otherwise ceases serving as the group owner or moves out of range of the other stations, the group owner may initiate an orderly shut down sequence in which it sends a message or other indicator that informs the other stations of the group owner's change in status. For instance, the message or other indicator, referred to herein as a status indicator, may be a beacon transmission with information that indicates the change in status. When the other stations receive such a beacon, they will reinitiate a master negotiation sequence to assign a new group owner. In some cases this renegotiation sequence may include some or all of the processes used in the association procedure described above in connection with FIG. 5. For instance, the stations may begin to periodically transmit their own beacon broadcasts or probe requests to begin the renegotiation process.

In some implementations the specific data indicating the group owner's change in status may be inserted in any appropriate field during the data frame body of the beacon transmission described above in connection with FIG. 6. For instance, the status indicator may be located either within the SSID field or within the IBSS field. Other possibilities for inserting the specific data, either within the beacon interval or elsewhere in the data frame body, may be conceivable as long as agreed to in a standard way. Indeed, any station of different manufacturers which has stored the status indicator will be able to insert it into a data frame by hardware and/or software components or modules devoted to constructing data frames for transmission and for decoding received data frames via a wireless link. The status indicator may take the form of a flag or the like that is defined by one or more data bits, for instance, that are inserted into the data frame.

The status data indicating that a station serving as the group owner will cease functioning in that role may be generated and transmitted upon the occurrence of a variety of different events. For instance, the data may be generated and transmitted when a failure in the station is detected which prevents it from serving as the group owner. Alternatively, the data may be generated and transmitted when the station receives any of a number of different user inputs such as a user input that powers down or otherwise turns off the station.

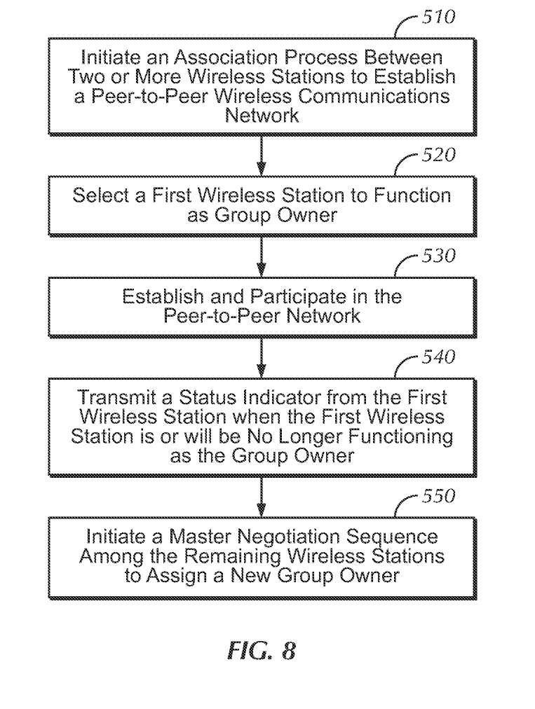

FIG. 7 shows one example of a wireless station 400 that may operate in a wireless P2P network that conforms to a standard such as IEEE 802.11, for example. The station 400 generally includes a radio frequency (RF) interface 410 and a baseband and medium access controller (MAC) processor portion 450. RF interface 410 may be any component or combination of components operative to send and receive multi-carrier modulated signals. In one example RF interface includes a receiver 412, transmitter 414 and frequency synthesizer 416. Interface 410 may also include bias controls and a crystal oscillator and/or one or more antennas 418. Furthermore, RF interface 410 may alternatively or additionally use external voltage-controlled oscillators (VCOs), surface acoustic wave filters, IF filters and/or RF filters. Various RF interface designs and their operation are known in the art and additional description thereof is therefore omitted.

In some cases RF interface 410 is configured to be compatible with one or more of the Institute of Electrical and Electronics Engineers (IEEE) 802.11 frequency band standards for wireless local area networks (WLAN). For example, RF interface 410 may be configured for compatibility and/or backward compatibility with the IEEE 802.11 (a-b) (g) and/or (n) standards.

Baseband and MAC processing portion 450 communicates with RF interface 410 to process receive/transmit signals and may include, by way of example only, an analog-to-digital converter 452 for down converting received signals, a digital to analog converter 454 for up converting signals for transmission, a baseband processor 456 for physical (PHY) layer processing of respective receive/transmit signals, and one or more memory controllers 458 for managing read-write operations from one or more internal and/or external memories (not shown). Processing portion 450 may also include processor 459 for medium access control (MAC)/data link layer processing. Processor 459 or additional circuitry (not shown) may be configured to perform the processes for constructing data frames with a shut down indicator for transmission and for decoding received data frames with a shut down indicator via a wireless link. Alternatively or in addition, baseband processor 456 may share processing for these functions or perform these processes independent of processor 459. MAC and PHY processing may also be integrated into a single component if desired.

The components and features of apparatus 400 may be implemented using any combination of discrete circuitry, application specific integrated circuits, logic gates and/or single chip architectures. Further, the features of apparatus 400 may be implemented using microcontrollers, programmable logic arrays and/or microprocessors or any combination of the foregoing where suitably appropriate. Although a specific architecture has been described in connection with apparatus 400, including specific functional elements and relationships, it is contemplated that the apparatus may be implemented in a variety of ways. For example, functional elements may be packaged together or individually, or may be implemented by fewer, more or different devices, and may be either integrated within other products, or adapted to work with other products externally. When one element is indicated as being responsive to another element, the elements may be directly or indirectly coupled.

FIG. 8 is a flowchart illustrating one example of a method for establishing a peer-to-peer wireless communications network. The method begins in step 510 when an association process is initiated between a group of wireless stations to establish a peer-to-peer wireless communications network. During or after this process a first of the wireless stations is selected in step 520 to function as the group owner during a negotiation process. Next, in step 530, the peer-to-peer network is established and each of the stations may participate in communicating with other stations and external networks, if available. When the first wireless station is or will be no longer functioning as the group owner, it transmits a status indicator in step 540 to inform the other stations of its change in status. Finally, the remaining wireless stations initiate a master negotiation sequence among the remaining wireless stations to assign a new group owner in step 550.

The processes described above, including but not limited to those presented in connection with FIG. 8, may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape and silicon memory (e.g., removable, non-removable, volatile or non-volatile).

1. A method, comprising:
participating in a peer-to-peer wireless communications network that includes a group controller for creating and ending the network and controlling access to the network by wireless stations; and
receiving a status indicator from the group controller indicating that the group owner is or will be no longer serving as group owner.

2. The method of claim 1 wherein the wireless communications network conforms to a IEEE 802.11 standard.

3. The method of claim 1 wherein the status indicator is included in a beacon transmission.

4. The method of claim 1 further comprising reinitiating a master negotiation sequence with remaining wireless stations in the peer-to-peer wireless communications network upon receiving the status indicator.

5. The method of claim 4 wherein the master negotiation sequence includes assigning one of the remaining wireless stations the role of group owner.

6. The method of claim 1 wherein each of the wireless stations is configured to be operable as the group controller.

7. The method of claim 6 further comprising identifying a remaining one of the wireless stations as a new group owner after receipt of the status indicator.

8. The method of claim 7 further comprising periodically transmitting a beacon broadcast to identify the new group owner.

9. A wireless station, comprising:
an RF interface configured to exchange wireless signals with remote devices over peer-to-peer connections in a wireless communications network having a group controller for creating and ending the network and controlling access to the network by the remote devices; and
a processor configured to detect a status indicator from the group controller indicating that the group owner is or will be no longer serving as the group owner.

10. The wireless station of claim 9 wherein the processor is further configured to generate a status indicator when the wireless station is acting as the group controller and will no longer be serving in that role.

11. The wireless station of claim 9 wherein the RF interface conforms to a IEEE 802.11 standard.

12. The wireless station of claim 9 wherein the status indicator is included in a beacon transmission.

13. The wireless station of claim 9 wherein the processor is further configured to reinitiate a master negotiation sequence with remaining wireless stations in the wireless communications network upon receiving the status indicator.

14. The wireless station of claim 13 wherein the master negotiation sequence includes assigning one of the remaining wireless stations the role of group owner.

15. At least one computer-readable medium encoded with instructions which, when executed by a processor, performs a method including:
arranging a first wireless station to function as a group controller in a peer-to-peer wireless communications network that includes a plurality of wireless stations including the first wireless station, wherein the group controller is configured to create and end the network and control access to the network by each of the wireless stations; and
transmitting a status indicator when the first wireless station is or will be no longer functioning as the group owner.

16. The computer-readable medium of claim 15 wherein the status indicator is transmitted upon receipt of user input.

17. The computer-readable medium of claim 15 wherein the status indicator is transmitted upon detection of a failure in the first wireless station.

18. The computer-readable medium of claim 15 wherein the wireless communications network conforms to a IEEE 802.11 standard.

19. The computer-readable medium of claim 18 wherein the status indicator is included in a beacon transmission.

20. The computer-readable medium of claim 15 wherein arranging the first wireless station to function as the group controller includes periodically transmitting a beacon broadcast from the first wireless station to initiate an association process, said beacon broadcast indicating that the first wireless station is able to serve as the group owner.
